(19) United States
(12) Patent Application Publication
(10) Pub. No.: US 2026/0228283 A1
(43) Pub. Date: Aug. 6, 2026

(54) REMOTE QUERYING OF INVERTED INDEXES

(71) Applicant: Microsoft Technology Licensing, LLC, Redmond, WA (US)

(72) Inventors: Armaan SOOD, Bellevue, WA (US); Rodrigo SIQUEIRA DE SOUZA, Seattle, WA (US); Hanumantha Rao KODAVALLA, Sammamish, WA (US); Krishnan SUNDARAM, Bothell, WA (US); Hari Sudan SUNDAR, Sammamish, WA (US); Tamara Grace HASS, Seattle, WA (US); Sreekanth KOLLA, Mill Creek, WA (US)

(21) Appl. No.: 19/043,374

(22) Filed: Jan. 31, 2025

(51) Int. Cl. G06F 16/903; G06F 16/901; G06F 16/93

(52) U.S. Cl. CPC G06F 16/90335; G06F 16/9027; G06F 16/93

(57) ABSTRACT

A database receives a query from a client for a database that has two segments. The query requires documents in the database having terms satisfying a criterion. Upon receiving the query, the system accesses a first inverted index in the first segment to find documents with terms that satisfy the expression. It identifies within the first segment first and second documents with first and second terms, respectively. Then, it accesses a second inverted index in the second segment and identifies an indication that the second term was removed from the second document. The database compiles a list of document identifiers, including the first document's identifier. The second document's identifier is excluded based on the removal indication. The list of document identifiers is used in generating a query response.

### BACKGROUND

Cloud providers offer, among other services, globally distributed, horizontally partitioned, multi-model database services. Some services are designed to allow customers to elastically scale throughput along with the storage across several geographical regions while offering guaranteed low latency, high availability, predictable throughput, and multiple well-defined consistency models. A few cloud-based database services also offer comprehensive Service Level Agreements (SLAs) encompassing dimensions such as throughput, latency at the 99th percentile, availability, and consistency. However, the different architectures such as “shared nothing” or “serverless” architectures implemented by many of the database services on the cloud platforms tend to be inelastic which can result in non-optimal use of system resources.

### SUMMARY

Example solutions for indexing data and processing a query using index data are described herein. The disclosed examples are described in detail below with reference to the accompanying drawing figures listed below. The following summary is provided to illustrate some examples disclosed herein.

In certain examples, a database receives a query from a client for a database that has two segments. The query requires documents in the database having terms satisfying a criterion. Upon receiving the query, the system accesses a first inverted index in the first segment to find documents with terms that satisfy the expression. It identifies within the first segment first and second documents with first and second terms, respectively. Then, it accesses a second inverted index in the second segment and identifies an indication that the second term was removed from the second document. The database compiles a list of document identifiers, including the first document's identifier. The second document's identifier is excluded based on the removal indication. The list of document identifiers is used in generating a query response.

### BRIEF DESCRIPTION OF THE DRAWINGS

The disclosed examples are described in detail below with reference to the accompanying drawing figures listed below:

FIG. 1A shows a block diagram of cloud platform implementing an example tiered data storage scheme;

FIG. 1B shows the cloud platform with a resource manager.

FIG. 2 shows a block diagram illustrating by way of example a representation of hot tier partition functionality.

FIG. 3A shows a flowchart illustrating by way of example a procedure for adding an inserted document to segment generation queue.

FIG. 3B shows a flowchart illustrating by way of example a procedure for updating a document maintained in the database by a partition.

FIG. 3C shows a flowchart illustrating by way of example a procedure for updating a segment generation queue in response to a document deletion.

FIG. 3D shows a flowchart illustrating by way of example a procedure for writing a segment to disaggregated storage.

FIG. 4 shows a graphical depiction of an example inverted index.

FIG. 5 shows a high-level block diagram illustrating an example procedure for searching disaggregated storage for documents satisfying a criterion provided by a query.

FIG. 6 shows a flowchart illustrating by way of example a procedure for processing a query.

FIG. 7 shows a flowchart illustrating by way of example a procedure for identifying documents having terms satisfying criteria of a query.

FIG. 8A illustrates an example data segment.

FIG. 8B illustrates by way of example compaction of a set of segments.

FIG. 9 shows a flowchart illustrating by way of example a procedure for compacting inverted index file.

FIG. 10A illustrates compaction where documents are only inserted

FIG. 10B illustrates compaction for documents that are inserted and deleted.

FIG. 11 is a block diagram of an example computing device for implementing computing operations disclosed herein.

Corresponding reference characters indicate corresponding parts throughout the drawings. Any of the figures may be combined into a single example or embodiment.

### DETAILED DESCRIPTION

For simplicity and illustrative purposes, the principles of the present disclosure are described by referring mainly to embodiments and examples thereof. In the following description, numerous specific details are set forth to provide an understanding of the embodiments and examples. However, benefits of the presently described technology may be achieved without many of the specific details described. In some instances, well-known methods and/or structures have not been described in detail so as not to unnecessarily obscure the description of the embodiments and examples. Furthermore, the embodiments and examples may be used together in various combinations.

An architecture that is widely in use in the database systems of cloud environments is the shared-nothing architecture, which provides storage and computing resources that are generally scaled together. Often, the much of the data in a cloud platform-based database, and in particular, older data is not regularly accessed. However, in a shared-nothing architecture, the rarely accessed data continues to be stored in data structures built for high-availability (HA) conditions that fulfill stringent performance requirements with minimal response times. While the users may require large data storage to store data that is constantly being generated by the various devices, high availability of all the data thus generated is neither necessary nor desired. This is because high availability translates into higher costs for data storage. For cloud providers, the shared-nothing data storage uses computational hardware resources that are better employed for other mission-critical applications. However, users may require at least a portion of the data to be accessible under HA conditions. Furthermore, the portion of data to be made available under HA conditions may differ from time to time. Many of these challenges can be addressed if the storage and computational resources can be scaled independently so that the computational resources can be flexibly assigned as required over a specified amount of data.

In contrast, described herein is a “shared-nothing/shared disk” based tiered storage system for cloud platforms which makes available a portion of the data that is frequently accessed as “hot data” that fulfills conditions for HA while another portion of the data that is less frequently accessed is stored as “cold data.” A resource management apparatus on the cloud platform includes a processor and memory storing processor-executable instructions as a request receiver, a data retriever, and a compute optimizer that enable implementation of the tiered storage. The hot data is stored in a local storage medium of a partition (e.g., a virtual machine (VM) or other virtual computing instance) on the cloud platform and the cold data is stored in a disaggregated storage medium that is shared by the partitions on the cloud platform. The partition receives data from a partition that is identified by a partition key. A local data manager within the partition stores the data including documents received from the partition to the local storage medium and in an in-memory table (memtable).

The memtable is an in-memory data structure that can have a fixed, predetermined maximum size and is used to store a copy of the hot data as a segment. When the memtable in a local storage medium attains the maximum size with the addition of the documents, the local data manager generates an immutable segment from the memtable and stores or flushes the immutable segment to the disaggregated storage medium. After the segment is flushed to the disaggregated storage, the memtable is deallocated by the local data manager, which continues to store the hot data in the local storage medium until certain criteria, e.g., time-to-cold (TTC criteria) are met. TTC criteria can include but are not limited to, temporal criterion, e.g., data is stored for a predetermined time, access criterion, e.g., data is accessed within a preceding predetermined time interval, or a combination of different criteria. When a memtable satisfies the TTC, the local data manager deletes the memtable from the local storage medium of the VM.

In an example, the local data manager formats the segment as a .avro file, i.e., in Avro format, which is a serialization framework created by the Apache Software Foundation based on JSON that serializes data into a compact binary format. While some examples are described herein with reference to the Avro and/or JSON formats, aspects of the disclosure are operable with other formats. The local data manager generates an inverted index for a segment that includes a range of search keys associated with the various documents stored therein. Each document of the segment is identified uniquely by a search key, which is a combination of the effective partition key and user identifier. identifying the partition from which the document was received and a document identifier (ID). The disaggregated storage manager groups segments in the disaggregated storage medium into sorted runs based on consecutive corresponding partition keys or non-overlapping search key ranges in an ascending or descending search key order. Furthermore, the disaggregated storage manager assigns levels to the sorted runs based on time stamps so that newly formed sorted runs are placed in higher levels. The disaggregated storage manager generates metadata maps for storing metadata of the segments and sorted runs, which enables identification of the segments for search or other purposes.

The resource management apparatus includes a document retriever that enables the retrieval of documents based on a received search string. If the search string includes the partition key and the document identifier (ID), the document retriever can retrieve the document so identified. If, however, the search string does not include a document ID, then documents from the partition identified by the partition key are retrieved. If the search string includes only a document ID, then documents across partitions having the document ID can be retrieved. The documents are identified based on the metadata of the segments and the sorted runs stored in the metadata maps. The management apparatus also includes a compute optimizer that enables scaling up or scaling down Request Units (RUs) per user requirements. An RU is a unit of compute or performance currency abstracting the system resources such as the Central Processing Unit (CPU), Input/Output Operations Per Second (IOPS), and memory that are required to perform database operations on a cloud computing platform. Whether the database operation is a write, point read, or query, operations are measured in RUs. By way of illustration and not limitation, a point read (fetching a single item by its ID and partition key value) for a 1-KB item can be one Request Unit (or one RU), regardless of the Application Programming Interface (API) used to interact with the database.

When a request to scale up compute or Request Units (RUs) is received for a portion of storage in the disaggregated storage medium, the RUs in terms of additional partitions are instantiated, and the metadata including the addresses of the segments in the portion of the storage medium is passed to the newly instantiated partition. Therefore, the partition gains a ‘view’ of the portion of the disaggregated storage medium so that point reads, or document retrieval is enabled. Conversely, if a request to scale down the compute resources is received for a portion of the storage in the disaggregated storage medium, the partition(s) corresponding to the segments in the portion of the storage is deleted.

The tiered storage for cloud platforms disclosed herein enables a hybrid shared-nothing/shared-disk LSM-tree-based storage architecture. The resource management apparatus executes the various processes via backend components and stores data in the disaggregated storage medium, for example, in an open-source file format (e.g., Avro).

The disclosed resource management apparatus and processes leverage the distributed nature of LSM-trees to provide for a technical improvement enabling scaling up or scaling down resources as needed without movement of data. Since segments are clustered by partition keys, physical partitions can be scaled up and down easily by being given a partition key range logical view. Thus, a view of immutable segments in the disclosed tiered storage scheme provides for greater elasticity as opposed to other architectures such as B-trees, where each compute instance may access fragmented pages of the mutable B-tree file which would require locking.

Another technical improvement afforded by the disclosed tiered storage is that it is elastic enough to be scaled across the shared-nothing/shared-disc by user workloads. For example, if a cloud subscriber requires high performance and availability for 100% of data, the subscriber can stay on a 100% shared-nothing architecture with the data being stored on the local storage only without being flushed to the disaggregated storage medium. If 100% performance is required only for 10% of data (hot data) and of data while resource efficiency/scalability, is preferred for the remaining 90% of the data then the service can switch to a hybrid shared-nothing/shared-disk architecture (tiered storage), allowing the 90% of data to be maintained in a disaggregated storage tier. If a customer prefers a serverless model where resources are assigned only when required, a 100% shared-disk architecture can be implemented so that the resource management apparatus can efficiently instantiate additional partitions without any data movement. Thus, the tiered storage scheme disclosed herein based on “shared-nothing, shared disc” architecture provides for a technical improvement over existing architectures in enabling more efficient or optimized use of computational resources at least because such resources can be instantiated as needed. The computational resources need not be assigned in advance as required by shared-nothing architecture nor do the computational resources have to be made completely inaccessible as in the serverless architecture.

A query processing strategy is provided for efficiently querying across immutable segments stored in the disaggregated (shared disk) storage tier. To efficiently process queries to LSM-tree segments, an inverted index is generated for each segment and is written to the segment along with the data being indexed. Processing queries across the segments can be relatively expensive but will be rare since the most often queried data will be the hot data maintained in the shared-nothing data tier. Maintaining inverted indexes within the data tier ensures that the inverted indexes and associated data are managed as a unit, e.g., during compaction of the LSM-tree segments. Furthermore, the approach described herein saves on in-memory and local disk storage as well as the cost to sort documents within the segments.

Accordingly, the technology described herein improves the efficiency of computing devices, for example, reducing power consumption, permitting queries to be performed efficiently across multiple data storage tiers. The database is optimized for write-intensive workloads in which hot data is rapidly searched and retrieved, while cold data is inexpensively maintained and efficiently indexed and searched.

### Platform Architecture

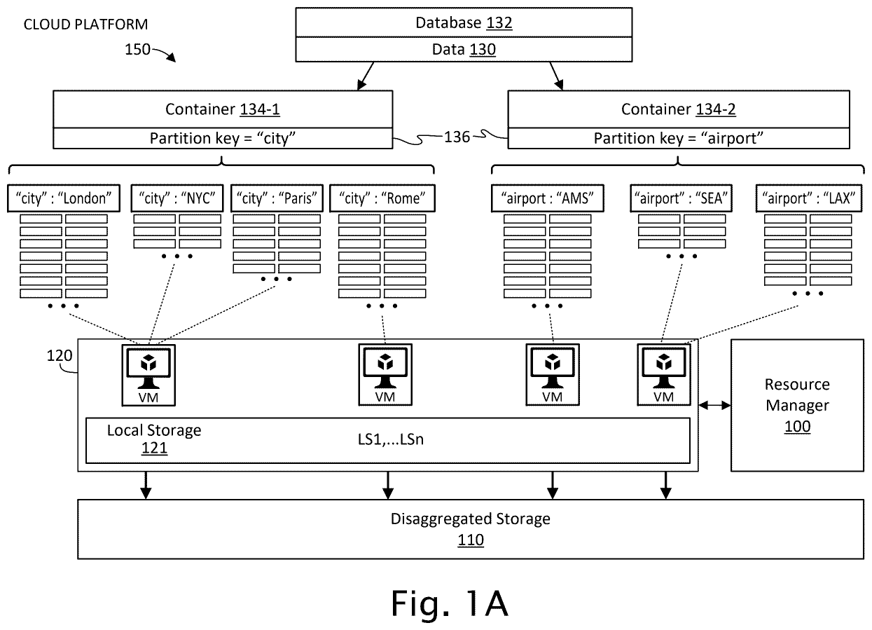

FIG. 1A shows a block diagram of cloud platform 150 implementing a tiered data storage scheme in accordance with an embodiment of the present disclosure. Cloud platform 150 receives data 130 from external data sources, e.g., database 132. By way of illustration and not limitation, a brief description of the external data sources is provided herein. In an example, the external data sources can be NoSQL data sources. Database 132 is logically partitioned into a number of containers or partitions 134-1 and 134-2 identified by corresponding partition keys 136 (PKs). For example, as shown in FIG. 1A, container 134-1 is characterized by partition key “city” while container 134-2 is characterized by partition key “airport.” Data 130 associated with different values of a particular partition key is transmitted to different VMs 120 on cloud platform 150. Resource manager 100 is also included in cloud platform 150. Each of the VMs also includes corresponding local storage (LS) which are numbered LS1 to LSn and referred to collectively as local storage 121. Disaggregated storage 110 is shared by VMs 120. Resource manager 100 implements a two-tiered data storage scheme for the clients of the cloud platform 150 based on the hybrid “shared nothing—shared disk” architecture. This architecture enables resource manager 100 to store data 130 as hot data on the hot tier including the local storage 121 and as cold data on the cold tier that includes the disaggregated storage 110 as further detailed herein.

FIG. 1B shows cloud platform 150 with resource manager 100, in accordance with an embodiment of the technology described herein. Resource manager 100 includes processor 102 coupled to data store 104 and memory 106 that stores modules with programming instructions to implement the tiered storage scheme disclosed herein. Memory 106 includes input receiver 162 that executes background processes to collect data 130 to be stored in the two data tiers of cloud platform 150. Memory 106 further includes disaggregated storage manager 164 that manages ‘hot data’ and ‘cold data’ in the hot and cold tiers. Data retriever 166 enables retrieval of records or documents from one or more of the local storages and disaggregated storage 110 and compute optimizer 168 instantiates new VMs or deletes existing VMs as needed for processing the cold data in disaggregated storage 110. The various operations and processes executed by the different components of cloud platform 150 enable resource-efficient two-tiered storage as will be further described herein.

Each of the VMs 120, e.g., VM 120-1, VM 120-2, . . . VM 120-n, hosted on cloud platform 150 is associated with a corresponding local storage LS1-LSn. In an example, the local storage of a VM can include a virtual disk maintained on a solid-state drive (SSD) of a computer that hosts the VM. The local storage of a given VM, e.g., LS1 of VM 120-1, is configured to store the data corresponding to the partition key(s). For example, if LS1 is the local storage for partition key {city=“London” } and data 130 includes an update to London data then disaggregated storage manager 164 stores the data 130 in LS1. Data corresponding to a particular partition key is not distributed across the local storage media. For example, LS1 stores all “hot” data 1301 for partition keys “London” and “NYC” so that this data is not stored in any other local storage media. Hot data 1301 in LS1 is deleted when preconfigured threshold criteria or condition(s) (Time to Cold (TTC)) are met. Each of the plurality of VMs 120 also includes a corresponding local data manager 138-1, 138-2, . . . 138-n.

A local data manager, e.g., local data manager 138-1, formats the data to be stored to disaggregated storage 110 into immutable “segments.” An immutable segment is a segment of data which, once sealed, is not modified. While the functions of the local data manager are described below with reference to the local data manager 138-1, it can be understood that such description is equally applicable to other local data managers 138-2, . . . , 138-n, unless otherwise specified. Local storage manager 138-1 writes documents into segments of data. When a segment is full, local data manager 138-1 seals the segment and stores a copy of the sealed segment in disaggregated storage 110. For example, the hot data 1301 in LS1 shows a partially filled segment, hot data 130₂ in LS2 shows a filled segment that can be sealed while hot data 130n in LSn shows an empty segment. The different segments (i.e., “segment 1” through “segment 7”) shown in disaggregated storage 110 are filled segments that were flushed from one or more of the local storage media LS1, LS2, . . . , LSn. Disaggregated storage manager 164 maintains one or more metadata maps 142 for identifying segments in the disaggregated storage medium 110 for query processing or other purposes as detailed herein.

In an example, disaggregated storage 110, which may be referred to as a single entity, includes a network of multiple storage devices that store data configured into a specific format by the manager 100.

Under the tiered storage scheme, access to hot data 130₁ stored on LS1 fulfills certain service level agreement (SLA) criteria which may specify terms such as high availability (HA), etc., while the access to cold data on disaggregated storage 110 does not fulfill the certain SLA (or fulfills a different SLA having lower requirements for data availability). Therefore, the resource manager 100 assigns computing resources, (e.g., request units (RUs)) to local data managers 138ₓ of VMs 120. When TTC for a set of hot data (e.g., a document) expires, local data manager 138-1 deletes the set of hot data 1301 of VM 120-1 from LS1 while cold data remains on the disaggregated storage 110. TTC can be set based on user requirements and criteria. TTC can be defined in terms of one or more criteria such as, but not limited to, temporal criteria, frequency and/or recency of access, etc.

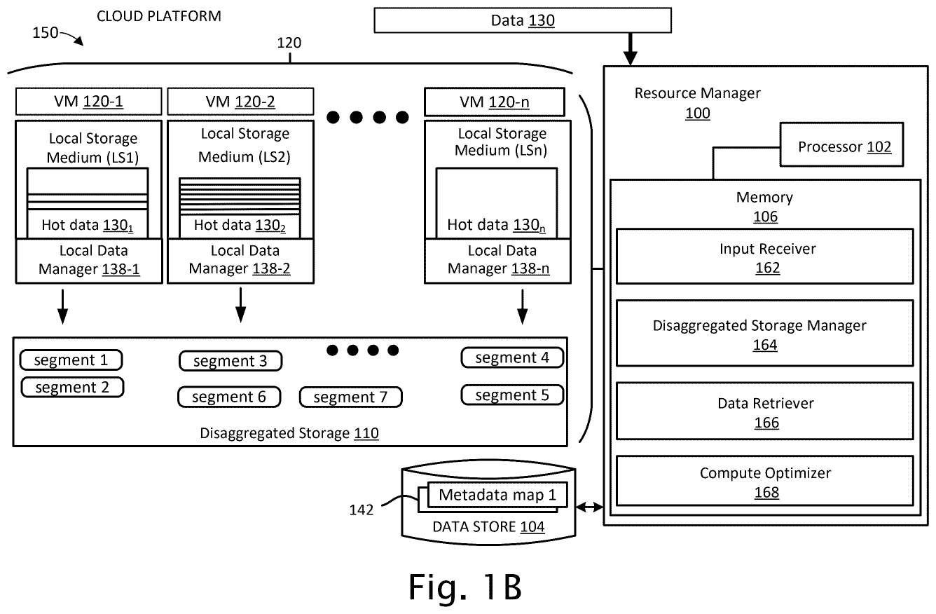

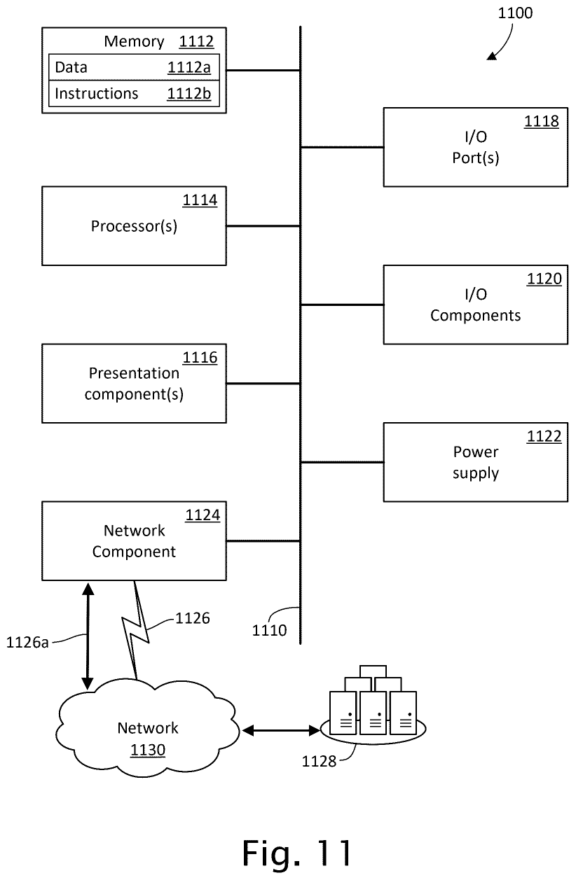

FIG. 2 shows a block diagram illustrating by way of example a representation 200 of hot tier partition functionality. In an exemplary implementation, partitions 210 are implemented by VMs 120-1 . . . 120-n, described above with reference to FIG. 1B. In alternative embodiments, each partition 210 comprises a physical computing instance or a distributed scalable containerized application having a microservices-based architecture, in which individual services may be shared by multiple partitions 210, while other services are specific to a particular partition. Regardless of the software architecture of partitions 210, it comprises software executing on physical computing hardware, such as that described below with reference to FIG. 11.

Each partition 210 comprises software illustrated in FIG. 2 by way of a set of functional blocks. Each functional block corresponds to segments of executable code for performing one or more functions. In exemplary embodiments, one or more functional blocks may correspond to, e.g., local data manager 138-n, illustrated and described above with reference to FIG. 1B. Therefore, functional blocks described herein may each be a component of a particular software application or service or may be separated into different software applications or services. Accordingly, FIG. 2 should be understood as representing various functionalities of partitions 210, not a particular architecture. Furthermore, it should be understood that representation 200 is not exhaustive of all functionalities of partitions 210, but illustrates certain functionalities pertinent to inverted index creation and querying mechanisms described herein, along with some useful contextual information. Functional blocks include API 212, query engine (QE) 214, iterator 215, indexer 216 and segment generator 218. In addition, certain data structures are illustrated, including document table (“doc table”) 222, segment generation queue 224, and tiered metadata table 230. Below partitions 210, disaggregated storage 110, described above with reference to FIGS. 1A and 1B, is illustrated.

API 212 provides a communication endpoint for database access requests and/or for control communication, e.g., from resource manager 100 as described above with reference to FIG. 1B. Database access requests include writes, reads, and queries. Write requests include “inserts” wherein a new document is stored to partition 210 and “updates” where a modified version of an existing document is stored to partition 210. In read requests, a document is retrieved by a user or client. Unless explicitly noted otherwise, the terms, “user” and “client” are used interchangeably and either term can refer to an individual or other entity such as a separate system. In a query, documents are searched to identify and retrieve information according to criteria defined in the query. In illustrative implementations, API 212 handles numerous other interactions for data management, node management, bulk operations, etc. In an example interaction, a client requests that document 1 (“Doc1”) be stored into the database. API receives the write requests and responds by storing a copy of document 1 into document table 222. In another example interaction, a client requests retrieval of document 2 (“Doc2”). In response, API fetches Document 2 from document table 222. In a third example interaction, API 212 retrieves a client request to process a query. In response to the query request, API 212 forwards the query to query engine (“QE”) 214.

Query engine 214 receives queries and processes them to identify information meeting the criteria defined in the query. While query engine 214 is shown in FIG. 2 as executing on partition 210, it may, in alternative implementations, reside outside of partition 210. For example, query engine 214 may reside on an external computer or node or service. For example, query engine 214 may be a component of data retriever 166 shown in FIG. 1B. To the extent that data from tiered metadata table 230 is required for processing queries (as further explained below) that data can be accessed remotely by an external query engine via API 212. By way of example, a query may request documents that mention a particular person's name. In response thereto, query engine 214 may search an inverted index (not shown) for any document stored locally that mentions the person's name, identify the corresponding documents, and return the list of documents to the client. As will be explained in further detail below, a query may implicitly or explicitly require searching disaggregated storage 110 for documents. Because of the immutable nature of segments contained within disaggregated storage 110, multiple inverted indexes are searched as explained in more detail below, e.g., using iterator 215.

Indexer 216 reads documents written to document table 222 and generates, for each document, a list of “plus-terms” and a list of “minus-terms.” The list of plus-terms includes any indexed term that is added to a document. For a new document, the list of plus-terms includes all indexed terms in the new document. For a revised document, the list of plus-terms includes all the indexed terms that appear in the revised version that were not present in the most recent version. Likewise, the list of minus-terms are terms that are present in the prior version of the document but are not present in the revised version. The indexer adds, for each document in document table 222, a list of plus-terms and minus-terms into a current segment 225 of generation queue 224.

Segment generator 218 reads documents from document table 222 and writes them into the current segment 225 in segment generation queue 224, also referred to herein as “memtable.” In addition, segment generator 218 generates metadata for the current segment and inserts the metadata for the current segment into metadata table 230. Metadata includes plus-terms and minus-terms for each document as well as two Bloom filters. Bloom filters are well-known probabilistic data structures that efficiently test whether an element is likely in a set or is definitely not in the set. It uses multiple hash functions to map elements to bits in a fixed-size array, enabling quick membership checks with minimal space but allowing false positives.

In an exemplary implementation, every document stored in cloud platform 150 is written in a data interchange format such as JavaScript Object Notation (JSON). Data interchange formats are characterized by being self-descriptive, extensible, platform independent, machine readable, and structured according to a hierarchical, nested structure. This means that they can be represented graphically as a tree structure having a root node and various branch nodes, and leaf nodes, wherein each node in the tree structure comprises a label, and leaf nodes additionally have a value associated with the label. While JSON is described herein as a common example data interchange format, other data interchange formats, such as Extensible Markup Language (XML), YAML Ain′t Markup Language (YAML) and protocol buffers (also referred to as “protobuffs”) are contemplated.

Each indexed term (e.g., a plus-term or a minus-term) comprises a path and a value for the path. For example, a path for document 1 can be “root.lastName” and the corresponding value is “Anderson.” Another path for document 1 could be “root.address.zip” and the value is “10451.” Of course, the internal representation of the path is arbitrary, but for purposes of explanation herein, the following notation will be used: The “roof” is replaced with a dollar sign (“$”), a period (“.”) will delimit nodes in the path, and a colon (“:”) will delimit the value. Therefore, the list of plus-terms for document 1, in this example, is written as {“$.lastName:Anderson”, “$.address.zip:10451” }.

Segment 1 241 through segment 6 246 are segments of an LSM-tree. LSM-trees are well-known write-optimized data structures designed for systems with frequent writes and high storage efficiency needs. Data is initially written to the memtable and periodically flushed as sorted immutable segments. LSM-trees are composed of a hierarchy of storage levels wherein each level, or tier, contains sorted data organized into distinct immutable segments. The newest data segments are conceptually added to the top level (Level 0) of the LSM-tree. As segments accumulate at a level, they are merged and compacted into the next level to reduce overlaps and maintain a globally sorted order across levels. Each subsequent level is typically larger and less fragmented than the previous one, storing consolidated data with minimal redundancy. This tiered design enables efficient writes by batching updates and deferring expensive merges while also supporting fast reads by maintaining sorted data and limiting the number of disk accesses needed to locate records.

### Segment Indexing

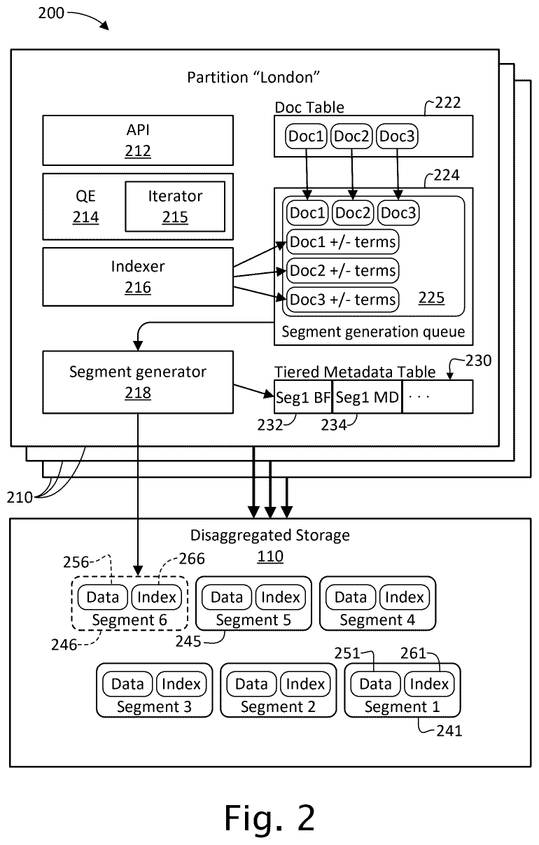

FIGS. 3A, 3B, 3C show flowcharts illustrating by way of example operations for adding documents and indexing data to segment generation queue. FIG. 3D illustrates a procedure for writing a new segment from the partition to the disaggregated storage.

Descriptions below of such operations include reference to components of partition 210 shown in FIG. 2. Operations are depicted as occurring in a particular order, but of course other orders of operations are possible, and further, in various implementations, additional operations are possible that are not shown and/or operations may be combined or divided into sub-operations without departing from the purpose and benefit of the methods described.

FIG. 3A shows flowchart illustrating by way of example a procedure 300 for adding an inserted document to segment generation queue 224. The procedure begins at start block 302 and proceeds to operation 304 in which a document insertion to the partition is detected. In response to detecting the document insertion, an ingester process (not separately shown but, in an exemplary implementation, is a component of API 212) copies the inserted document to segment generation queue 224. In an exemplary implementation, an operation logger (not shown) detects the document insertion (e.g., via a notification from API 212 or by monitoring document table 222) and stores a copy of the inserted document to an operation log table while the ingester process reads the inserted document from the operation log table and copies the document to segment generation queue 224.

In operation 308, plus-terms (“+terms”) are generated for the inserted document and added to segment generation queue 224. Since the document is identified as “inserted” there is no prior version of the document in the database. In one implementation, the document is identified as “inserted” by searching for, and not finding, a matching document identifier in an inverted index. In an alternative implementation, the API can distinguish between inserted and updated documents based on distinct interactions for each. Since inserted documents have no prior versions, the new document is parsed and all indexed terms in the new document are added to the list of plus-terms for the new document. The procedure then ends as indicated by block 310. In an exemplary implementation, identification of which terms, if not all terms, are to be indexed is defined within the document itself and/or in accordance with a user-defined policy. Upon completion of the generation of the list of plus-terms, the procedure ends as indicated by block 310.

FIG. 3B shows a flowchart illustrating by way of example a procedure 320 for updating a document maintained in the database by partition 210. The procedure begins as indicated at start block 322 and proceeds to operation 324 wherein a document update is detected. In exemplary implementations, all document updates occur by storing a new and complete version of the document. The update therefore includes old data as well as new data, and not just changes from the previous version of the document. In response to detecting the document update, in operation 326, a copy of the document is added to segment generation queue 224.

In operation 328 terms added to and removed from the updated document are identified and a plus-term list and a minus-term list is generated. If the last version of the document resides in document table 222, then the updated document replaces the last version, and a local indexer 216 generates plus-terms and minus-terms corresponding to the updated document. It is expected that this is the most common case because updates to documents generally happen within the TTC period, within which the most recent version of the document will be retained in the memory of the partition. In this case, the plus- and minus-terms are entirely generated for the updated without requiring access to disaggregated storage 110.

Upon expiration of the TTC period, the document is deleted from document table 222. If the prior document no longer resides in document table 222, the plus- and minus-terms are generated by accessing index data contained in disaggregated storage 110. In an example process, a Bloom filter 232 is consulted for each segment 241-246 stored in disaggregated storage 110 to identify every segment that might contain a version of the document. As will be discussed in further detail below, tiered metadata table 230 is maintained which includes, for each segment written by the partition to disaggregated storage 110, a Bloom filter (e.g., Bloom filter 232) that is keyed to the search key. In a representative embodiment, the document identifier includes a user-defined component, and a user identifier. The document identifier is input into the Bloom filter associated with each segment to determine if the segment likely contains the document. Each Bloom filter then returns a “likely” or a “no.” If a “likely” is returned for a particular segment, then the inverted index for the segment is accessed to determine whether the segment contains the document If the particular segment contains the document, then a “point-read” is performed to fetch the most recent prior version of the document from disaggregated storage 110. From the most recent prior version, a list of terms is extracted, which is then compared with the terms extracted from the update document to generate the plus-terms and minus-terms. In an alternate implementation, the inverted index is read to retrieve a set of plus-terms and minus-terms from each segment that contains a prior version of the document, which are then aggregated, providing a complete, i.e., full-fidelity, list of indexed terms of the most recent prior version of the document, which can be compared with the updated document to generate a new list of plus- and minus-terms.

Returning to FIG. 3B, operation 328, once indexed terms of the last version of the document is determined as described above, that list of index terms is compared with the updated document to determine plus- and minus-terms for the updated document. Then in operation 330, the list of plus- and minus-terms are added to the segment generation queue.

The procedure then ends as indicated by block 332.

FIG. 3C shows a flowchart illustrating by way of example a procedure 340 for updating a segment generation queue in response to a document deletion. Procedure 340 begins as indicated by start block 342 and proceeds to operation 344 wherein a document deletion tag (or indicator) is added to document table 222. Segment generator 218, e.g., via a subscription to an operations log (not shown) detects the document deletion. In response thereto, the process flows to operation 346 wherein segment generator 218 adds a document deletion tag or indicator to segment generation queue 224. In operation 348, minus-terms are computed using an approach, similar to the approach described above with reference to FIG. 3B. Since the document is deleted, all terms in the full-fidelity inverted index for the last version of the document are added as minus-terms, and there will be no plus-terms. In operation 350, the list of minus-terms is added to segment generation queue 224. The procedure then ends as indicated by block 352.

FIG. 3D shows a flowchart illustrating by way of example a procedure 360 for writing a segment to disaggregated storage 110. The procedure begins as indicated by start block 362 and proceeds to operation 364 wherein an event is detected. The event may be that segment generation queue 224 is full or otherwise has reached or has approached its maximum size, or the event may be a time-based trigger (e.g., every 30 seconds), or some combination thereof.

As previously explained, the event for writing data to segmented storage 110 is, in an exemplary embodiment, independent of the TTC criteria (also referred to as tiering-out criteria) which is user configurable.

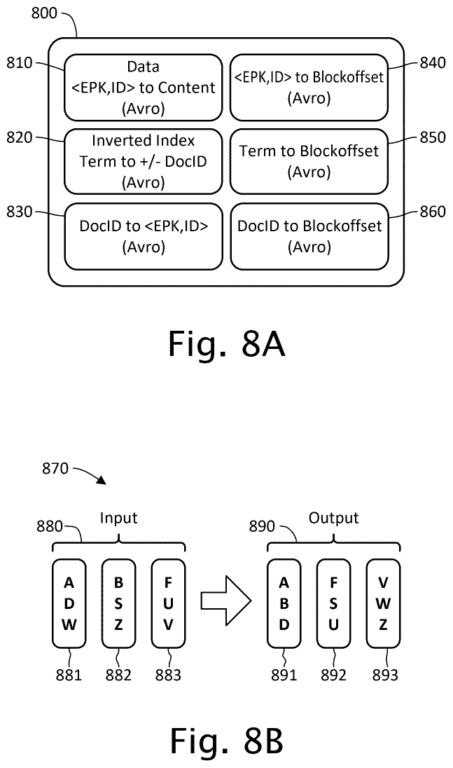

In response to the detection of the event, procedure 360 flows to operation 366 wherein the in-memory segment generation queue is flushed to a new immutable segment written to disaggregated storage 110. In an exemplary embodiment, the new segment is a binary large object (BLOB) and is immutable, meaning the new segment is not modified once it is written to disaggregated storage 110. However, refer to the discussion below with reference to FIGS. 8A-10B, for a process for combining and/or compacting multiple segments to generate new segment(s) that replaces the input multiple segments.

As further described below with reference to FIG. 8, each segment written to disaggregated storage 110 includes, by way of example, six files: A first file is a data file 810 that (a) maps the search key to data content, i.e., stored documents and (b) entries denoting a deleted document that include a mapping from the search key to empty content. In an exemplary implementation, the data file is in Avro format.

A second segment file (e.g., file 820 in FIG. 8A) comprises an inverted index. An inverted index is a data structure that maps terms to the documents containing them, similar to an index at the back of a textbook which identifies the page that a particular term appears.

TABLE 1

| Term | Bitmap ID | Doc IDs |
|---|---|---|
| $.lastName:Anderson | 0 | −10, +15 |
| $.lastName:Miller | 0 | +14, +15, +17 |
| $.lastName:Smith | 0 | −2, +15, +22 |
| $.address.zip:10451 | 0 | +7 |
| $.address.zip:10451 | 1 | +5, −4, +3 |

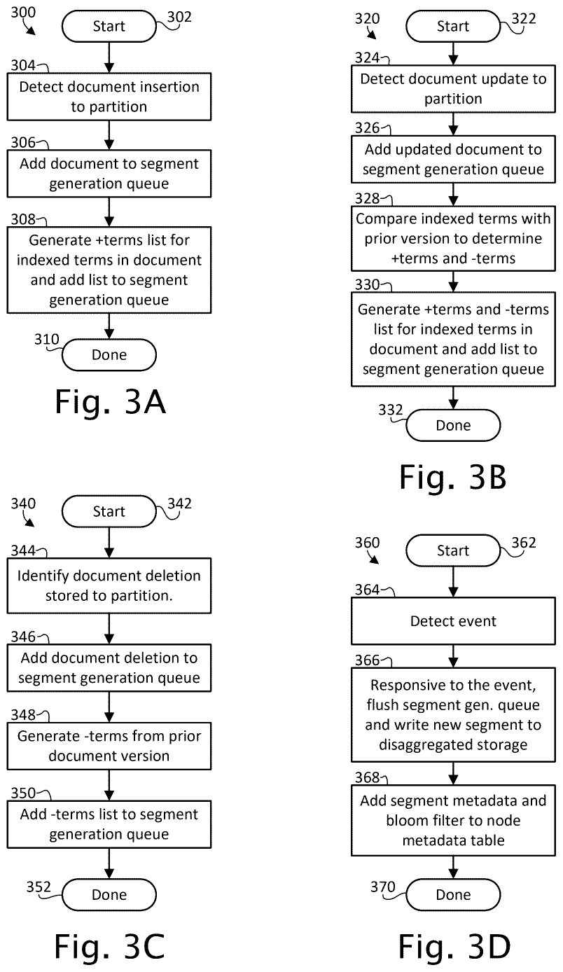

Table 1 illustrates an example inverted index written to a particular segment comprising a set of plus-terms and minus-terms. Each row in Table 1 corresponds to a particular index term, and includes a path and value, a bitmap identifier, and a list of document identifiers for which the term is added or removed. The first entry includes path “root.lastName” with value “Anderson.” The list of document IDs identify all documents in which the value “Anderson” was added or removed from the location in the document identified by the path, “root.lastName.” In the list of document identifiers, the term, “−10” indicates that at the location within the document defined by the path, “root.lastName,” “Anderson” was removed from document 10, and the term, “+15” indicates that “Anderson” was added at that location to document 15. There may be additional document versions in other segments, but this inverted index only identifies document versions stored locally within the same segment in which the inverted index is stored. As explained above, all the inverted indexes for all the segments written by a particular partition collectively define a full-fidelity inverted index for all documents stored by the partition. However, individually, each segment includes an inverted index that is pertinent only to the documents stored on that segment. FIG. 4 shows a graphical depiction of an example inverted index and is further described below.

In an exemplary embodiment, document IDs are encoded into bitmaps (not shown) wherein each bit in the bitmap corresponds to a particular document. The bitmap can be of arbitrary length, but to fit into modern CPU registers, the bitmap length is capped at some number of bits, e.g., based on the target CPU environment. Modern CPUs, such as Intel x64 processors with AVX-512 vector extensions can process and perform bit-wise operations on up to 512-bit binary numbers. Other CPUs are capable of performing bit-wise operations on different length binary numbers. Based on this limitation, when the maximum number of documents that can fit into a bitmap is exceeded, a new bitmap is created, and the bitmap identifier is used to identify each bitmap. Furthermore, in an exemplary embodiment, for each indexed term there is a “plus bitmap” and a “minus bitmap” (not shown). By way of example, for a plus-bitmap for the term, “Anderson,” if a bit in position 15 (i.e., the 15^{th} bit from the least-significant bit) is set, i.e., has the value of “1,” then the value “Anderson” was added to document 15. Likewise, for a minus-bitmap for the term, “Anderson,” if the 10^{th} bit is set to “1,” then the value “Anderson” was removed from document 10. Multiple bitmaps may need to be searched for each term, as illustrated in Table 1 by the last two entries (rows) which have the same path and value but differing bitmap identifiers.

Returning to FIG. 3D, in operation 366, A third segment file (file 830 in FIG. 8A) written to the segment in disaggregated storage 110 provides a mapping between document identifier and the search key. This file has all search keys present in the segment's data file so that at query time, when a point lookup on the document identifier is performed and the segment containing that document identifier is found which leads to the search key, the corresponding search key to data mapping does not require an additional lookup. The third segment file also includes all document identifiers that are present in the segment's inverted index, including negative document identifiers (as further explained below).

The fourth through sixth segment files (e.g., files 840, 850, and 860 in FIG. 8A) provide primary key index files for each of the first through third files to identify Avro block metadata records, which help navigate and more efficiently access the Avro-formatted data files. For the fourth file, the primary key is the search key and maps to the first (data) file, for the fifth file, the primary key is the term plus the bitmap identifier and maps to the inverted index. For the sixth file the primary key is the document identifier and maps to the document identifier mapping of the third file. As used herein unless context dictates otherwise, the terms, “first,” “second, “third,” etc. are not intended to denote a specific order or ranking, but are merely used here to distinguish one file from another. The terms, “first” and “second” for example, could easily be reversed without any substantive differences in the segment structure.

Returning again to FIG. 3D, in operation 368, segment metadata is added to tiered metadata table 230. Segment metadata includes two Bloom filters and additional information relevant to the segment stored to disaggregated storage 110. A first Bloom filter is based on the data file (i.e., the data portion of the segment) to do efficient point lookups. A second Bloom filter, previously described with reference to FIGS. 3B above, is based on a document identifier for efficiently identifying whether a document exists in the segment based on the document identifier. Additional metadata includes information such as the location of each of the six files within the segment.

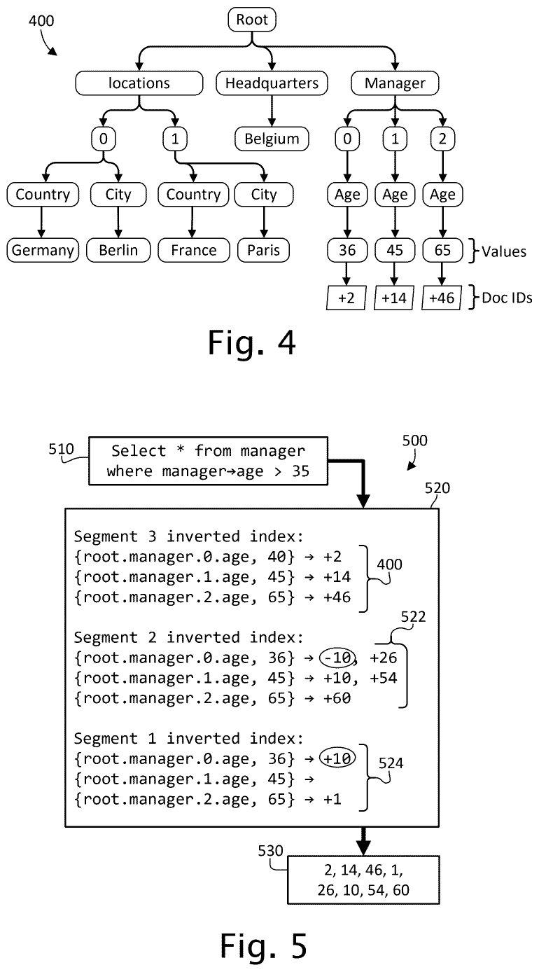

FIG. 4 shows a directed graph illustrating by way of example an inverted index 400 associated with a particular segment, “Segment 3” as referenced in FIG. 5, discussed below. Inverted index 500 includes a root node with two branch nodes labeled “Locations” and “Manager.” In addition, a leaf node labeled “Headquarters” is directly connected to the root node. The “Locations” branch node has two sub-branches. The Manager branch node has three sub-branches with paths “$.Manager.0.Age,” “$.Manager.1.Age” and “$.Manager.2.Age” with corresponding values “36,” “45,” and “65.” For sake of brevity, only the “Age” values “36,” “45,” and “65” are indexed with document identifiers.

### Querying Logic

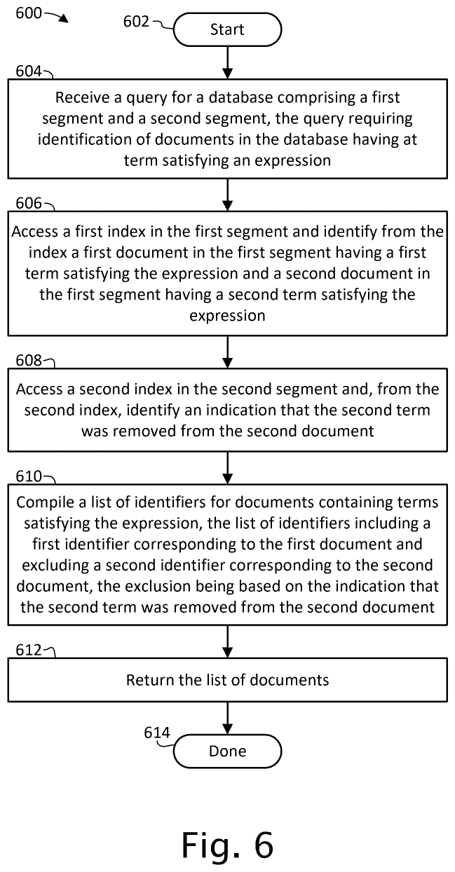

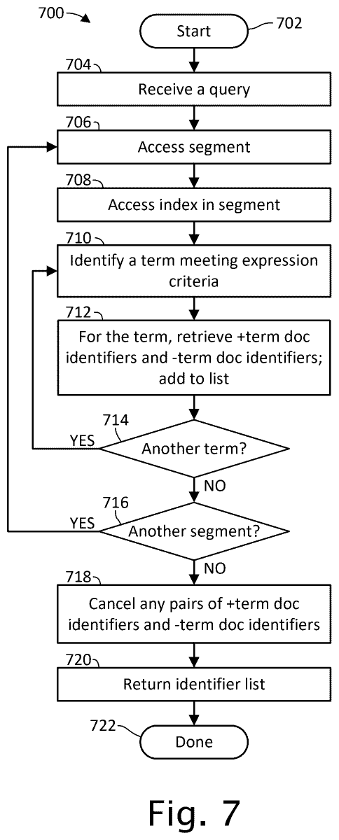

FIG. 5 shows a high-level block diagram illustrating a procedure 500 for searching disaggregated storage 110 for documents satisfying one or more criteria provided by a query. In the present example, query 510 is received, e.g., by query engine 214 (FIG. 2), requiring data from documents where a manager age is higher than “35.” (The syntax used herein is in pseudo-SQL format for purposes of illustrating how inverted indexes are searched, not to show an actual query.) As described in further detail below with reference to FIGS. 6 and 7, inverted indexes 400, 522, and 524 are retrieved and evaluated to identify all documents that satisfy the criteria defined in the query. Each inverted index indicates documents for which the sought terms are added (plus-docs) and removed (minus-docs).

For example, in inverted index 522, the term “$.manager.0.age:36” was removed from document 10 and added to document 26. The circled document identifiers (“+10” and “−10”) show that the term “$.manager.0.age.36” was added to document 10 in segment 1 and removed from document 10 in segment 2; therefore, these terms cancel out (as will be further explained below with references to FIGS. 6 and 7). It should be noted that the order that the segments were written to disaggregated storage 110 is immaterial to the query processing logic. While it is impossible for a term to be removed before it is added, it can be assumed here that we do not know, and it does not matter, whether segment 1 was written before or after segment 2. After canceling out any pairs of matching plus and minus document identifiers, a compiled list of document identifiers 530 is returned to the client. List of document identifiers 530 includes document 10 because, although the circled plus-document and minus-document numbers cancel out, document 10 was also added in segment 2 for the term, “$.manager.1.age:45”. The same result would have occurred if the term that was removed in Segment 2 (“$.root.manager.0.age:36”) was added back in in Segment 3. In this case one of the “+10” terms would have been cancelled by the “−10” term, and the other would remain. It should therefore be understood that each plus-document and minus-document number is evaluated on a per-term basis.

FIG. 6 shows a flowchart illustrating by way of example a procedure 600 for processing a query. Procedure 600 begins at start block 602 and proceeds to operation 604 wherein a query is received for a database comprising a first segment and a second segment of data. The terms, “first” and “second” are not intended to imply any order or ranking, and are used herein only to distinguish one segment from the other. The query requires identification of documents in the database having a term satisfying an expression. By way of example, query 510 of FIG. 5 requires identification of all documents having a term satisfying criteria that a manager has an age greater than 35. It should be noted that the query need not explicitly request the document identifiers. Rather, as in this example case, the query may simply require data from the documents that meet the criteria and, therefore, to access the data, the query requires that the document identifiers for those documents be determined.

In response to receiving the query in operation 604 the procedure flows to operation 606 wherein a first inverted index in the first segment is accessed. In an embodiment, all segments associated with a partition are accessed to read inverted indexes therefrom. Procedure 600 does not limit the number of segments to two, but for sake of discussion only addresses operations related to the first and second segments. From the first inverted index, a first document in the first segment having a first term that satisfies the expression is identified. Furthermore, a second document in the first segment having a second term that satisfies the expression is identified. For example, referring to FIG. 5, the expression to be satisfied is that “manager.age” is greater than 35. In segment 1, a first term is “$.manager.1.age:45” which satisfies the expression that manager.age >35, while a second term, “$.manager.0.age:36” also satisfies the same expression.

In operation 608, a second inverted index is accessed from the second segment, and from the second inverted index, an indication is identified that the second term was removed from the second document. This operation can be illustrated again by referencing FIG. 5, wherein a minus-document “−10” is indicated in the inverted index for Segment 2, showing that the term “$.manager.0.age:36” was removed from the version of document 10 residing in Segment 2.

In operation 610, query engine 214 compiles a list of identifiers for documents containing terms satisfying the expression. The list includes the first identifier e.g., “document 45” from FIG. 5, and excludes the second identifier, e.g., “document 10” from FIG. 5, where the exclusion is based on the indication that the second term (“$.manager.0.age:36”) was removed from the second document (i.e., document 10). In other words, the indication that the second term was removed cancels out the indication that the second term was added in the inverted index for the first segment.

Upon compiling the list of document identifiers, the list is returned in operation 612. The list is returned for further processing by query engine 214 or the list is returned to the client. The procedure then ends as indicated by block 614.

FIG. 7 shows a flowchart illustrating by way of example a procedure 700 for identifying documents having terms satisfying criteria of a query. The procedure begins as indicated by start block 702 and proceeds to operation 704 wherein a query is received. In an exemplary embodiment, the query may be a “sub-query” or portion of an original query that requires simply to return the identifiers for documents having terms satisfying certain criteria. In the example of FIG. 5, the criterion is that the documents to be returned must have terms for managers' age where the age is greater than 35. This criterion may be passed to an iterator 215 (FIG. 2), e.g., as a separate process, which then performs the remainder of procedure 700.

At operation 706, iterator 215 accesses a segment. The order of segment access is not important for the proper operation of procedure 700. Once a segment is identified for accessing, the inverted index from the accessed segment is accessed in operation 708. Then in operation 710, the inverted index is searched to identify terms that satisfy the criterion. Then in operation 712, a plus-term document identifiers (also referred to as “plus-document identifiers”) and minus-term document identifiers (also referred to as “minus-document identifiers”) are retrieved from the inverted index. For the term, there may be zero or more plus-term document identifiers and zero or more minus-term document identifiers, but at least one plus-term document identifier or minus-term document identifier will be present in the inverted index. In operation 712, the retrieved plus- and minus-term document identifiers are added to a list corresponding to the term that satisfies the criteria.

In decision block 714, it is determined whether any additional terms that satisfy the criteria are present and if so, the procedure returns to operation 710. Otherwise, the procedure flows to decision block 716 wherein it is determined whether another segment is present. All segments associated with the partition relevant to the query are eventually searched, but it does not matter in what order they are searched. If another segment is present, the procedure returns to operation 706 to access the next segment. Otherwise, the procedure flows to operation 718.

In operation 718, for each term in all inverted indexes across all the segments associated with the partition that satisfy the criteria, the list of plus-document identifiers and minus-document identifiers are processed to identify pairs of plus- and minus-document identifiers that cancel out. A pair of identifiers cancel out if they have the same value except for having opposite signs—i.e., a “+10” will cancel out a “−10.” Once canceled pairs of identifiers are returned, an aggregated list of document identifiers from all the lists associated with the terms is compiled and returned in operation 720. The procedure then ends as indicated by block 722.

### Compaction

LSM-trees are well known data structures that organize data segments into multiple levels or tiers of storage, with each level holding larger and more compacted data segments.

Compaction of LSM-tree data is the process of combining multiple segments. Compaction combines and reorganizes segments to reduce the number of files, eliminating redundant and outdated information, maintains sorting of data, and reduces the number of segments that need to be searched when performing reads. During compaction, segments are read, merged, and rewritten into fewer, larger segments. Compacted data is moved to the next level which can store larger files with fewer overlaps.

Compaction is performed by a compactor process (not shown) executing on each partition 210. In an alternative implementation, a compaction service executes outside of partition 210, e.g., under control of resource manager 100 (FIG. 1A, 1B) or on behalf of each partition 210.

Compaction is initiated based on a compaction policy, which may be determined globally or as a user configuration. In an example implementation, compaction is initiated when the number of segments at a given level exceeds a threshold. Compactions strategy relates to how segments are combined and promoted to additional levels. Certain strategies such as 1-levelling and L-levelling are known and are contemplated. In these strategies, the lowest level consists of a single large segment containing the oldest data.

FIG. 8A illustrates an example segment 800. Segment 800 includes a data file 810, an inverted index file 820, a Document identifier to search key mapping file 830. For each file 810, 820, and 830, there is a corresponding Blockoffset index file 840, 850, and 860, respectively. all files 810-860 are stored as Avro-formatted files.

Data file 810 contains documents organized, i.e., sorted, by search key, comprising the effective partition key (EPK) and user identifier. Data in inverted index file 820 is sorted by term and then by document identifier. Data in document identifier to search key mapping file 830 is sorted by document identifier.

FIG. 8B illustrates by way of example compaction of a set of segments. Compaction 870 processes a set of input segments 880 to generate a set of output segments 890. Input segments 880 comprise segments 881, 882, and 883. Segment 881 includes data corresponding to search keys A, D, and W. These search key identifiers are for the purposes of illustration of the sorting process and should be considered placeholders for actual search keys. Segment 882 includes data corresponding to search keys B, S, and Z. Finally segment 883 contains data corresponding to search keys F, U, and V. Data file 810 is ordered by search key. Because the output of the compaction process is a new sorted run ordered by search key, it is efficient to generate a sorted set of data files by opening an iterator on the first input segment per sorted run. The smallest search key entry is added to the output file in each iteration. When the output file reaches a certain size threshold (e.g., when D is added to segment 891), a new segment (e.g., segment 892) is created and the iterator continues. When there are overlapping search keys, the newer version is retained.

Because inverted index file 820 and document identifier to search key mapping file 830 are not ordered by search key, they cannot be efficiently merged in the same manner as document file 810 described with reference to FIG. 8B.

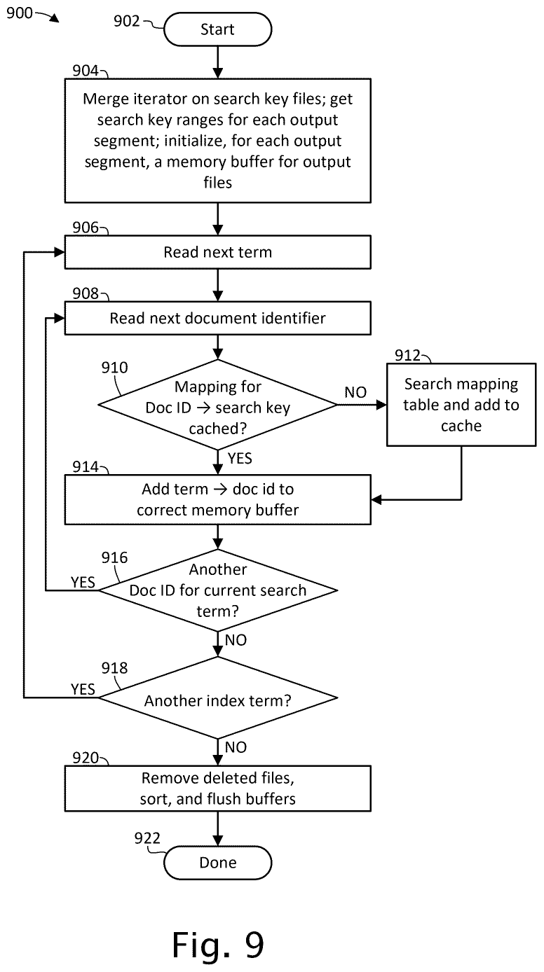

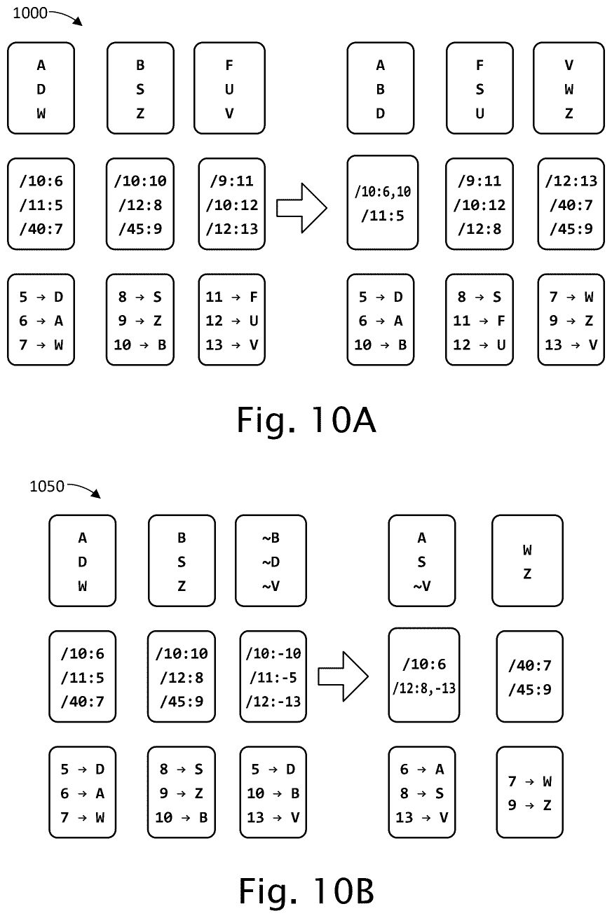

FIG. 9 shows a flowchart illustrating by way of example a procedure 900 for compacting inverted index file 820. In the description of FIG. 9 to follow, reference will be made to FIGS. 10A and 10B. FIG. 10A illustrates compaction where documents are only inserted; FIG. 10B illustrates compaction for documents are inserted and deleted. In FIGS. 10A and 10B, each box corresponds to a file as previously described. The first row of files corresponds to document files, the second row corresponds to inverted index files, and the third row corresponds to document identifier to search key mapping files. The first through third column of files corresponds to first through third input segments, respectively; the fourth through sixth column of files corresponds to first through third output segments, respectively. For purposes of explanation, search keys are replaced with letters, index terms for documents are replaced with slash-numbers (e.g., “/10”) and document identifiers are replaced with numbers.

Referring to FIG. 9, procedure 900 starts as indicated by start block 902 and proceeds to operation 904 wherein a merge iterator processes document files by search keys in the input segments. This process is explained in more detail above with reference to FIGS. 8A and 8B. For each output segment, a memory buffer for each output file is initialized. Although the approach is useful for other types of files, this procedure will focus on the inverted index file. In the example of FIG. 10A, three inverted index file buffers are initialized, one for each output segment. In the example of FIG. 10B, there are only two output segments, so only two memory buffers need be initialized for the output inverted index files corresponding to each of the two output segments.

Then in operation 906, a next index term is read. Index terms are explained above with reference to FIGS. 4 and 5 and Table 3. In one implementation, all the index terms for the input segments are concatenated and one index term is read at a time. In another implementation, the index terms are combined and sorted before being processed. Referring to FIG. 10A, an initial term in the first segment's inverted index is /10.

In operation 908, a next document identifier for the term read in operation 906 is identified. In the example case, the first (and only) document identifier associated with term “/10” is a document associated with document identifier “6.”

In decision block 910, it is determined whether a mapping for the document identifier (e.g., document identifier “6”) is cached. In an example implementation, an in-memory cache is maintained for mappings from document identifier to search key. If the cache grows too large, the in-memory cache spills over to a sorted local disk file with least recently used (LRU) data being written to the disk file. If the mapping is not present in the cache, the procedure proceeds to operation 912 wherein the mapping table is consulted to obtain the search key for the document identifier read in operation 908. In the example shown in FIG. 10A, the document identifier “6” maps to segment A, which, in operation 904, was placed in the first output segment as shown n the output segment in the top row, forth column, indicating documents having search keys “A” “B” and “D.”

Once the search key for the document identifier is determined, the procedure flows to operation 914, wherein the term and document identifier are added to the correct memory buffer. In the example shown in FIG. 10A, the correct memory buffer is the one corresponding to the first output segment, since that is the one that has the document with search key “A.”

Next in decision block 916, it is determined whether there is an additional document identifier for the current term. If there is an additional document identifier, then the procedure returns to operation 908 to read the next document identifier. Referring again to the example shown in FIG. 10A, if the terms are sorted, then a next document identifier is “10” followed by “12” since documents associated with document identifiers “10” and “12” both include the index term “/10” and are present in the second and third input segments, respectively.

If, at decision block 916, there are no more document identifiers associated with the current term, the procedure flows to decision block 918 to determine if there is another index term in the list. If there are additional index terms, then the procedure returns to operation 906. In the example shown in FIG. 10A, the next index term in the first input segment is “/11”, so the procedure would return to operation 906.

Once all the index terms are processed, procedure 900 flows to operation 920 wherein deleted files are removed from the buffers, the data is sorted in each buffer, and the buffers are flushed to the new output segments. The procedure then ends as indicated by block 922.

In the example of FIG. 10B, two documents inserted into the first and second input segments, plus a third document, are deleted in the third input segment. In FIG. 10B, a tilde before a search key identifier indicates that the document associated with the search key identifier is deleted in the third segment. It should be noted that, during operation 920, documents associated with document identifiers 5, 10, and 13 are deleted. Documents 5 and 10 correspond with search keys “B” and “D” and were inserted in the first and second input segments respectively. Since the documents were deleted, they can be removed from the buffers associated with the output segments. However, document 13, which is also deleted, is associated with a document that was inserted in a segment that is not included in this compaction round. Therefore, the first output segment maintains the indication that the deleted document 13 (and the indication “~V” is kept in the buffer and output to the first output segment so that if and when the first output segment is compacted with additional other segments that include the insertion of document 13, then the indication of the deletion will be relied upon to delete document 13 in that subsequent compaction.

### Additional Examples

An example computer system comprises a processor and a memory storing software arranged to execute on the processor, the software comprising instructions operative upon execution by the processor to: receive a query for a database, the database comprising a first segment and a second segment, the query being received from a client and requiring identification of documents in the database that have a term satisfying an expression; responsive to the receiving of the query: access a first inverted index in the first segment and, from the first inverted index, identify a first document in the first segment having a first term that satisfies the expression and a second document in the first segment having a second term that satisfies the expression; access a second inverted index in the second segment and, from the second inverted index, identify an indication that the second term was removed from the second document; compile a list of identifiers for the documents containing the term, the list of identifiers including a first identifier corresponding to the first document and excluding a second identifier corresponding to the second documents, the exclusion of the second identifier being based on the indication that the second term was removed from the second document; and return the list of identifiers to the client.

Alternatively, or in addition to the other examples described herein, examples include any combination of the following:
Wherein the accessing of the second inverted index further comprises from the second inverted index, identifying a third document in the second segment in which a third term satisfies the expression; and the list of identifiers includes an identifier a third identifier corresponding to the third document.
Wherein the instructions are further operative upon execution to: receive, in response to a write request, a document for storage in a local memory of the computer system; and, in response to the receiving of the write request: store the document in a local document table; generate and locally store a list of plus-terms for the document, the list of plus-terms comprising terms included in the document; and add the document and the list of plus-terms to a segment generation queue; and upon an occurrence of an event, flush the segment generation queue, the flushing of the segment generation queue combining writing a third segment to the database, the third segment comprising the document and a third inverted index including the list of plus-term
Wherein: the document is a modification of the first document; the list of plus-terms comprise terms added to the first document by the modification of the first document; the instructions are further operative upon execution to generate and locally store a list of minus-terms for the document, the list of minus-terms comprising terms that were removed from the first document by the modification of the first document; and the third inverted index includes the list of minus-terms.
Wherein: the first inverted index comprises a tree data structure including a leaf node identifying the term in the first document in the first segment; the leaf node is associated with a first list of document identifiers corresponding to a first plurality of documents in the first segment in which the term was added, the first list of document identifiers including the first document identifier and the first plurality of documents including the first document; and the leaf node is associated with a second list of document identifiers corresponding to a second plurality of documents in the first segment in which the term was removed.
Wherein the first list comprises a first bitmap and the second list comprises a second bitmap.
Wherein the first segment is stored as a first binary large object (BLOB) and the second segment is stored as a second BLOB.

An example computerized method for querying data in a disaggregated storage tier of a database comprises: receiving a query for data contained in the disaggregated storage tier, the query being received from a client and requiring identification of documents in the disaggregated storage tier that have a term satisfying an expression; in response to the receiving of the query: accessing a first inverted index in a first data segment stored in the disaggregated storage tier and, from the first inverted index, identifying a first document in the first data segment having a first term that satisfies the expression and identifying a second document in the first data segment having a second term that satisfies the expression; accessing a second inverted index in a second data segment stored in the disaggregated storage tier and, from the second inverted index, identifying an indication that the second term was removed from the second document; compiling a list of identifiers for the documents containing the term, the list of identifiers including a first identifier corresponding to the first document and excluding a second identifier corresponding to the second documents, the exclusion of the second identifier being based on the indication that the second term was removed from the second document; and using the list of identifiers to generate a response to the query.
Wherein: the accessing of the second inverted index further comprises from the second inverted index, identifying a third document in the second data segment in which a third term satisfies the expression; and the list of identifiers includes an identifier a third identifier corresponding to the third document.
Wherein the method further comprises: receiving, in response to a write request, a document for storage in a local memory of a partition of the database; and, in response to the receiving of the write request: storing the document in a local document table; generating and locally store a list of plus-terms for the document, the list of plus-terms comprising terms included in the document; and adding the document and the list of plus-terms to a segment generation queue; and upon an occurrence of an event, flushing the segment generation queue, the flushing of the segment generation queue combining writing a third data segment to the disaggregated storage tier, the third data segment comprising the document and a third inverted index including the list of plus-terms.
Wherein: the document is a modification of the first document is associated with the first document identifier; the list of plus-terms comprise terms added to the first document by the modification of the first document; the method further comprises generating and locally storing a list of minus-terms for the document, the list of minus-terms comprising terms that were removed from the first document by the modification of the first document; and the third inverted index includes the list of minus-terms.
Wherein the first inverted index comprises a tree data structure based on a document hierarchy, the tree data structure including a leaf node identifying a term in at least one document in the first data segment, the leaf node being associated with a first list of document identifiers corresponding to a first plurality of documents in the first data segment in which the term was added and a second list of document identifiers corresponding to a second plurality of documents in the first data segment in which the term was removed.
Wherein the first and second lists each comprise a bitmap.
Wherein the first data segment is stored as a first binary large object (BLOB) and the second data segment is stored as a second BLOB.

An example computer-readable storage medium stories instructions executable by a processing apparatus to perform operations that comprise: writing a first data segment to a disaggregated storage tier of a database, the first data segment being an immutable segment comprising a data file and an inverted index file, the data file comprising a plurality of documents each having a document identifier, the inverted index file having a plurality of terms corresponding to terms in the plurality of documents, each of the plurality of terms in the inverted index file having associated therewith at least one document identifier and for each document identifier a plus-indication or a minus-indication, the plus-indication indicating that the term was added to a version of the document corresponding to the document identifier that resides in the first data segment, the minus-indication indicating that, for the version of the document residing in the first data segment, the term was removed from an earlier version of the document; receiving a query for the database, the database comprising the first data segment and a second data segment, the query being received from a client and requiring identification of documents in the disaggregated storage tier that have a term satisfying an expression; responsive to the receipt of the query: accessing a first inverted index in the first data segment and, from the first inverted index, identifying a first document in the first data segment having a first term that satisfies the expression and a second document in the first data segment having a second term that satisfies the expression; accessing a second inverted index in the second data segment and, from the second inverted index, identify an indication that the second term was removed from the second document; compiling a list of identifiers for the documents containing the term, the list of identifiers including a first identifier corresponding to the first document and excluding a second identifier corresponding to the second documents, the exclusion of the second identifier being based on the indication that the second term was removed from the second document; and generating a response to the query using the list of identifiers.
Wherein: the accessing of the second inverted index further comprises from the second inverted index, identifying a third document in the second data segment in which a third term satisfies the expression; and the list of identifiers includes an identifier a third identifier corresponding to the third document.
Wherein the operations further comprise: receiving, in response to a write request, a received document for storage in a local memory of a partition of the database; and, in response to the receiving of the write request: storing the received document in a local document table; generating and locally storing a list of plus-terms for the received document, the list of plus-terms comprising terms included in the document; and adding the received document and the list of plus-terms to a segment generation queue; and upon an occurrence of an event, flushing the segment generation queue, the flushing of the segment generation queue including writing a third data segment to the database, the third data segment comprising the document and a third inverted index including the list of plus-terms.
Wherein: the document is a modification of the first document; the list of plus-terms includes only terms added to the first document by the modification of the first document; the operations further comprise generating and locally storing a list of minus-terms for the received document, the list of minus-terms comprising terms that were removed from the first document by the modification of the first document; and the third inverted index includes the list of minus-terms.
Wherein the first inverted index comprises a tree data structure including a leaf node identifying the term in at the first document in the first data segment; the leaf node being is associated with a first list of document identifiers corresponding to a first plurality of documents in the first data segment in which the term was added, the first list of document identifiers including the first document identifier and the first plurality of documents including the first document; and the leaf node is associated with a second list of document identifiers corresponding to a second plurality of documents in the first data segment in which the term was removed.
Wherein the first and second lists each comprise a bitmap.

An example method for merging a first inverted index of a first segment and a second inverted index of a second segment comprises: reading a first index term from the first inverted index; reading a first document identifier associated with the first index term, the first document identifier corresponding to a first document; in response to the first index term being associated with the first document identifier which corresponds to the first document, identifying an output segment for containing the first document; adding a first mapping to an output buffer corresponding to the output segment, the first mapping associating the first index term and the first document identifier; reading a second index term from the second inverted index; reading a second document identifier associated with the second index term, the second document identifier corresponding to a second document; in response to the second index term being associated with the second document identifier which corresponds to the second document, identifying the output segment for containing the second document, wherein the output segment is designated for including the first document and the second document; adding a second mapping to the output buffer, the second mapping associating the second index term and the second document identifier; generating an output inverted index file from the output buffer, the output inverted index file including the first mapping and the second mapping; and including the output inverted index file in the output segment.

Alternatively, or in addition to the other examples described herein, examples include any combination of the following:
Wherein the method further comprises: reading a third document identifier associated with the first index term, the third document identifier corresponding to a third document; identifying a second output segment for containing the third document; adding a third mapping to a second output buffer corresponding to the second output segment, the third mapping associating the first index term with the third document identifier; generating a second output inverted index file from the second output buffer, the second output inverted index file including the third mapping; and including the second output inverted index file in the second output segment.
Wherein the identifying of the output segment for containing the first document comprises, using a table mapping document identifiers to search keys, identifying a search key associated with the document identifier, and then determining the output segment from search key based on the search key being within a range of search keys assigned to the output segment.

### Example Operating Environment

FIG. 11 is a block diagram of an example computing device 1100 for implementing computing operations disclosed herein, designated generally as computing device 1100. In some examples, one or more computing devices 1100 are provided for an on-premises computing solution. In some examples, one or more computing devices 1100 are provided as a cloud computing solution. In some examples, a combination of on-premises and cloud computing solutions are used. Computing device 1100 is but one example of a suitable computing environment and is not intended to suggest any limitation as to the scope of use or functionality of the examples disclosed herein, whether used singly or as part of a larger set.

Neither should computing device 1100 be interpreted as having any dependency or requirement relating to any one or combination of components/modules illustrated. The examples disclosed herein can be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples can be practiced in a variety of system configurations, including personal computers, laptops, smart phones, mobile tablets, hand-held devices, consumer electronics, specialty computing devices, etc. The disclosed examples can also be practiced in distributed computing environments when tasks are performed by remote-processing devices that are linked through a communications network.

Computing device 1100 includes a bus 1110 that directly or indirectly couples the following devices: computer storage memory 1112, one or more processors 1114, one or more presentation components 1116, input/output (I/O) ports 1118, I/O components 1120, a power supply 1122, and a network component 1124. While computing device 1100 is depicted as a seemingly single device, multiple computing devices 1100 can work together and share the depicted device resources. For example, memory 1112 is distributed across multiple devices, and processor(s) 1014 is housed with different devices.

Bus 1110 represents one or more buses (such as an address bus, data bus, or a combination thereof). Although the various blocks of FIG. 11 are shown with lines for the sake of clarity, delineating various components can be accomplished with alternative representations. For example, a presentation component such as a display device is an I/O component in some examples, and some examples of processors have their own memory.

Distinction is not made between such categories as “workstation,” “server,” “laptop,” “hand-held device,” etc., as all are contemplated within the scope of FIG. 11 and the references herein to a “computing device.” Memory 1112 can take the form of the computer storage media referenced below and operatively provide storage of computer-readable instructions, data structures, program modules and other data for the computing device 1100. In some examples, memory 1112 stores one or more of an operating system, a universal application platform, or other program modules and program data. Memory 1112 is thus able to store and access data 1112a and instructions 1112b that are executable by processor 1114 and configured to carry out the various operations disclosed herein.

In some examples, memory 1112 includes computer storage media. Memory 1112 can include any quantity of memory associated with or accessible by the computing device 1100. Memory 1112 can be internal to the computing device 1100 (as shown in FIG. 11), external to the computing device 1100 (not shown), or both (not shown). Additionally, or alternatively, the memory 1112 can be distributed across multiple computing devices 1100, for example, in a virtualized environment in which instruction processing is carried out on multiple computing devices 1100. For the purposes of this disclosure, “computer storage media,” “computer-storage memory,” “memory,” and “memory devices” are synonymous terms for the computer-storage memory 11012, and none of these terms include carrier waves or propagating signaling.

Processor(s) 1114 includes any quantity of processing units that read data from various entities, such as memory 1112 or I/O components 1120. Specifically, processor(s) 1114 are programmed to execute computer-executable instructions for implementing aspects of the disclosure. The instructions can be performed by the processor, by multiple processors within the computing device 1100, or by a processor external to the client computing device 1100. In some examples, the processor(s) 1114 are programmed to execute instructions such as those illustrated in the flow charts discussed below and depicted in the accompanying drawings. Moreover, in some examples, the processor(s) 1114 represent an implementation of analog techniques to perform the operations described herein. For example, the operations are performed by an analog client computing device 1100 and/or a digital client computing device 1100. Presentation component(s) 1116 present data indications to a user or other device. Exemplary presentation components include a display device, speaker, printing component, vibrating component, etc. It should be understood that computer data can be presented in a number of ways, such as visually in a graphical user interface (GUI), audibly through speakers, wirelessly between computing devices 1100, across a wired connection, or in other ways. I/O ports 1118 allow computing device 1100 to be logically coupled to other devices including I/O components 1120, some of which can be built in. Example I/O components 1120 include, for example but without limitation, a microphone, joystick, game pad, satellite dish, scanner, printer, wireless device, etc.

Computing device 1100 can operate in a networked environment via the network component 1124 using logical connections to one or more remote computers. In some examples, the network component 1124 includes a network interface card and/or computer-executable instructions (e.g., a driver) for operating the network interface card.

Communication between the computing device 1100 and other devices can use any protocol or mechanism over any wired or wireless connection. In some examples, network component 1124 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 1124 communicates over wireless communication link 1126 and/or a wired communication link 1126a to a remote resource 1128 (e.g., a cloud resource) across network 1130. Various different examples of communication links 1126 and 1126a include a wireless connection, a wired connection, and/or a dedicated link, and in some examples, at least a portion is routed through the internet.

Although described in connection with an example computing device 1100, examples of the disclosure are capable of implementation with numerous other general-purpose or special-purpose computing system environments, configurations, or devices. Examples of well-known computing systems, environments, and/or configurations that suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices might accept input from the user in any way, including from input devices such as a keyboard or pointing device, via gesture input, proximity input (such as by hovering), and/or via voice input.

Examples are described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform particular tasks or implement particular abstract data types. Aspects of the disclosure can be implemented with any number and organization of such components or modules. For example, aspects of the disclosure are not limited to the specific computer-executable instructions or the specific components or modules illustrated in the figures and described herein. Other examples of the disclosure include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium for storing information for access by a computing device. In contrast, communication media typically embody computer readable instructions, data structures, program modules, or the like in a modulated data signal such as a carrier wave or other transport mechanism and include any information delivery media.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

In examples involving a general-purpose computer, aspects of the disclosure transform the general-purpose computer into a special-purpose computing device when configured to execute the instructions described herein.

It will be understood that the benefits and advantages described above can relate to one embodiment or to several embodiments. The embodiments are not limited to those that solve any or all of the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

In some examples, the operations illustrated in the figures are implemented as software instructions encoded on a computer storage medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing a particular operation before, contemporaneously with, or after another operation is within the scope of aspects of the disclosure.

As used herein, the term “set” is non-empty, and can also be referred to as a “group.”

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there might be additional elements other than the listed elements. The term “exemplary” is intended to mean “an example of” The phrase “one or more of the following: A, B, and C” means “at least one of A and/or at least one of B and/or at least one of C.”

While the aspects of the disclosure have been described in terms of various examples with their associated operations, a person skilled in the art would appreciate that a combination of operations from any number of different examples is also within scope of the aspects of the disclosure.

1. A computer system comprising:
a processor; and
a memory storing software arranged to execute on the processor, the software comprising instructions operative upon execution by the processor to:
receive a query for a database, the database comprising a first segment and a second segment, the query being received from a client and requiring identification of a document in the database that have a term satisfying an expression;
responsive to the receiving of the query:
access a first inverted index in the first segment and, from the first inverted index, identify a first document in the first segment having a first term that satisfies the expression and a second document in the first segment having a second term that satisfies the expression;
access a second inverted index in the second segment and, from the second inverted index, identify an indication, stored within the second inverted index, that the second term was removed from the second document;
compile a list of identifiers for documents containing the term, the list of identifiers including a first identifier corresponding to the first document and excluding a second identifier corresponding to the second document, the exclusion of the second identifier being based on the indication that the second term was removed from the second document; and
generate a response to the query using the list of identifiers.

2. The computer system of claim 1, wherein:
the accessing of the second inverted index further comprises from the second inverted index, identifying a third document in the second segment in which a third term satisfies the expression; and
the list of identifiers includes a third identifier corresponding to the third document.

3. The computer system of claim 1, wherein the instructions are further operative upon execution to:
receive, in response to a write request, a document for storage in a local memory of the computer system; and, in response to the receiving of the write request:
store the document in a local document table;
generate and locally store a list of plus-terms for the document, the list of plus-terms comprising terms included in the document; and
add the document and the list of plus-terms to a segment generation queue; and
upon an occurrence of an event, flush the segment generation queue, the flushing of the segment generation queue comprising writing a third segment to the database, the third segment comprising the document and a third inverted index including the list of plus-terms.

4. The computer system of claim 3, wherein:
the document is a modification of the first document;
the list of plus-terms comprise terms added to the first document by the modification of the first document;
the instructions are further operative upon execution to generate and locally store a list of minus-terms for the document, the list of minus-terms comprising terms that were removed from the first document by the modification of the first document; and
the third inverted index includes the list of minus-terms.

5. The computer system of claim 1, wherein:
the first inverted index comprises a tree data structure including a leaf node identifying the term in the first document in the first segment;
the leaf node is associated with a first list of document identifiers corresponding to a first plurality of documents in the first segment in which the term was added, the first list of document identifiers including the first identifier and the first plurality of documents including the first document; and
the leaf node is associated with a second list of document identifiers corresponding to a second plurality of documents in the first segment in which the term was removed.

6. The computer system of claim 5, wherein the first list comprises a first bitmap and the second list comprises a second bitmap.

7. The computer system of claim 1, wherein the first segment is stored as a first binary large object (BLOB) and the second segment is stored as a second BLOB.

8. A computerized method for querying data in a disaggregated storage tier of a database, the method comprising:
receiving a query for data contained in the disaggregated storage tier, the query being received from a client and requiring identification of a documentin the disaggregated storage tier that have a term satisfying an expression;
in response to the receiving of the query:
accessing a first inverted index in a first data segment stored in the disaggregated storage tier and, from the first inverted index, identifying a first document in the first data segment having a first term that satisfies the expression and identifying a second document in the first data segment having a second term that satisfies the expression;
accessing a second inverted index in a second data segment stored in the disaggregated storage tier and, from the second inverted index, identifying an indication, stored within the second inverted index, that the second term was removed from the second document;
compiling a list of identifiers for documents containing the term, the list of identifiers including a first identifier corresponding to the first document and excluding a second identifier corresponding to the second document, the exclusion of the second identifier being based on the indication that the second term was removed from the second document; and
return the list of identifiers to the client.

9. The computerized method of claim 8, wherein:
the accessing of the second inverted index further comprises from the second inverted index, identifying a third document in the second data segment in which a third term satisfies the expression; and
the list of identifiers includes a third identifier corresponding to the third document.

10. The computerized method of claim 8, wherein the method further comprises:
receiving, in response to a write request, a document for storage in a local memory of a partition of the database; and, in response to the receiving of the write request:
storing the document in a local document table;
generating and locally storing a list of plus-terms for the document, the list of plus-terms comprising terms included in the document; and
adding the document and the list of plus-terms to a segment generation queue; and
upon an occurrence of an event, flushing the segment generation queue, the flushing of the segment generation queue comprising writing a third data segment to the disaggregated storage tier, the third data segment comprising the document and a third inverted index including the list of plus-terms.

11. The computerized method of claim 10, wherein:
the document is a modification of the first document associated with the first identifier;
the list of plus-terms comprise terms added to the first document by the modification of the first document;
the method further comprises generating and locally storing a list of minus-terms for the document, the list of minus-terms comprising terms that were removed from the first document by the modification of the first document; and
the third inverted index includes the list of minus-terms.

12. The computerized method of claim 8, wherein the first inverted index comprises a tree data structure based on a document hierarchy, the tree data structure including a leaf node identifying the term in at least one document in the first data segment, the leaf node being associated with a first list of document identifiers corresponding to a first plurality of documents in the first data segment in which the term was added and a second list of document identifiers corresponding to a second plurality of documents in the first data segment in which the term was removed.

13. The computerized method of claim 12, wherein the first and second lists each comprise a bitmap.

14. The computerized method of claim 8, wherein the first data segment is stored as a first binary large object (BLOB) and the second data segment is stored as a second BLOB.

15. A non-transitory computer-readable storage medium storing instructions executable by a processing apparatus to perform operations comprising:
writing a first data segment to a disaggregated storage tier of a database, the first data segment being an immutable segment comprising a data file and an inverted index file, the data file comprising a plurality of documents each having a document identifier, the inverted index file having a plurality of terms corresponding to terms in the plurality of documents, each of the plurality of terms in the inverted index file having associated therewith at least one document identifier and for each document identifier a plus-indication or a minus-indication, the plus-indication indicating that the term was added to a version of a document corresponding to the document identifier that resides in the first data segment, the minus-indication indicating that, for the version of the document residing in the first data segment, the term was removed from an earlier version of the document;
receiving a query for the database, the database comprising the first data segment and a second data segment, the query being received from a client and requiring identification of a document in the disaggregated storage tier that have a term satisfying an expression;
responsive to the receipt of the query:
accessing a first inverted index in the first data segment and, from the first inverted index, identifying a first document in the first data segment having a first term that satisfies the expression and a second document in the first data segment having a second term that satisfies the expression;
accessing a second inverted index in the second data segment and, from the second inverted index, identify an indication, stored within the second inverted index, that the second term was removed from the second document;
compiling a list of identifiers for documents containing the term, the list of identifiers including a first identifier corresponding to the first document and excluding a second identifier corresponding to the second document, the exclusion of the second identifier being based on the indication that the second term was removed from the second document; and
generating a response to the query using the list of identifiers.

16. The computer-readable storage medium of claim 15, wherein:
the accessing of the second inverted index further comprises from the second inverted index, identifying a third document in the second data segment in which a third term satisfies the expression; and
the list of identifiers includes a third identifier corresponding to the third document.

17. The computer-readable storage medium of claim 15, wherein the operations further comprise:
receiving, in response to a write request, a received document for storage in a local memory of a partition of the database; and, in response to the receiving of the write request:
storing the received document in a local document table;
generating and locally storing a list of plus-terms for the received document, the list of plus-terms comprising terms included in the document; and
adding the received document and the list of plus-terms to a segment generation queue; and
upon an occurrence of an event, flushing the segment generation queue, the flushing of the segment generation queue including writing a third data segment to the database, the third data segment comprising the document and a third inverted index including the list of plus-terms.

18. The computer-readable storage medium of claim 17, wherein:
the document is a modification of the first document;
the list of plus-terms includes only terms added to the first document by the modification of the first document;
the operations further comprise generating and locally storing a list of minus-terms for the received document, the list of minus-terms comprising terms that were removed from the first document by the modification of the first document; and
the third inverted index includes the list of minus-terms.

19. The computer-readable storage medium of claim 15, wherein:
the first inverted index comprises a tree data structure including a leaf node identifying the term in the first document in the first data segment;
the leaf node is associated with a first list of document identifiers corresponding to a first plurality of documents in the first data segment in which the term was added, the first list of document identifiers including the first identifier and the first plurality of documents including the first document; and
the leaf node is associated with a second list of document identifiers corresponding to a second plurality of documents in the first data segment in which the term was removed.

20. The computer-readable storage medium of claim 19, wherein the first and second lists each comprise a bitmap.
